(19) United States
(12) Patent Application Publication
(10) Pub. No.: US 2011/0265288 A1
(43) Pub. Date: Nov. 3, 2011

(54) TWO-STAGE DUAL-PINTLE HINGE

(76) Inventor: Yung-Chang CHIANG, Taipei County (TW)

(21) Appl. No.: 12/770,335

(22) Filed: Apr. 29, 2010

(51) Int. Cl. E05D 11/08; E05D 3/06

(52) U.S. Cl. 16/341; 16/366; 16/337; 16/371

(57) ABSTRACT

A two-stage dual-pintle hinge mainly includes at least one connecting element which has two apertures run through by a first axis and a second axis in the same direction. The first axis and the connecting element form a first pivot displacement, and the second axis and the connecting element form a second pivot displacement. The first and second axes have respectively a first anchor portion and a second anchor portion. The connecting element has a corresponding third anchor portion. During the first pivot displacement, the first anchor portion and the third anchor portion form an anchor relationship and drive the second pivot displacement of the connecting element and the second axis. During the second pivot displacement, the second anchor portion and the third anchor portion form an anchor relationship to stop pivoting.

### FIELD OF THE INVENTION

The present invention relates to a two-stage dual-pintle hinge and particularly to a dual-pintle hinge equipped with two single-pintle hinges that can be pivoted in a two-stage manner.

### BACKGROUND OF THE INVENTION

The conventional flip-lid electronic device (such as notebook computer, mobile phone and the like) generally has a hinge to bridge a display and a keyboard, and provide a torsional force required for lifting the display against the keyboard. The conventional hinge generally has a single-pintle. While it allows the display to be lifted and pivoted against the keyboard, it has only one axis and the axis cannot be altered during swiveling.

To remedy the aforesaid problem, a “dual-pintle” hinge has been developed as disclosed in PCT patent No. WO 2007/029546. It proposes a dual-pintle hinge to bridge two frames of an electronic device, and mainly includes a rotary cam run through by two switch shafts. The switch shaft has a fixed cam and a spring, and the two single-pintle hinges are juxtaposed in an integrated manner to allow the two frames to be unfolded in various types to increase degrees of freedom of swiveling angle.

However, the successive movements of the two single-pintle hinges of the aforesaid dual-pintle hinge cannot be controlled as desired. In the same flipping movement, sometimes one of the single-pintle hinges pivots, sometimes another single-pintle hinge pivots, or two of them pivot at the same time. As a result, the flipping condition is unpredictable to the user. Moreover, anchoring effect of the frames is merely relied on the rotary cam and fixed cam, the cam surfaces have to support the weight of the frames for a long time and be worn off quickly, thus result in a shorter lifespan.

### SUMMARY OF THE INVENTION

Therefore, the primary object of the present invention is to provide a dual-pintle hinge that can be pivoted at two stages in a sequence and provide a longer lifespan.

To achieve the foregoing object, the present invention provides a two-stage dual-pintle hinge that mainly includes a first axis, a second axis and at least one connecting elements. The first axis has a first torsion unit and a first anchor portion. The second axis has a second torsion unit and a second anchor portion. The connecting element has two apertures run though by the first and second axes in the same direction, such that the first axis and the connecting element form a first pivot displacement between them, and the second axis and the connecting element form a second pivot displacement between them. The connecting element has a third anchor portion corresponding to the first and second anchor portions. The first anchor portion and the third anchor portion form an anchor relationship in the first pivot displacement to drive the second pivot displacement. During the second pivot displacement, the second anchor portion and the third anchor portion form an anchor relationship.

By means of the structure set forth above, only the first stage pivot displacement between the first axis and connecting element has been finished, the second stage pivot displacement between the connecting element and second axis can be driven, so that pivot displacements are performed in a constant sequence. Moreover, both the first and second axes can form anchoring effect with the connecting element to provide auxiliary support and increase the life span.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 3 is another exploded view of the invention.

FIGS. 4A through 4C are schematic views of the invention in operating conditions.

### DETAILED DESCRIPTION OF THE PREFERRED EMBODIMENTS

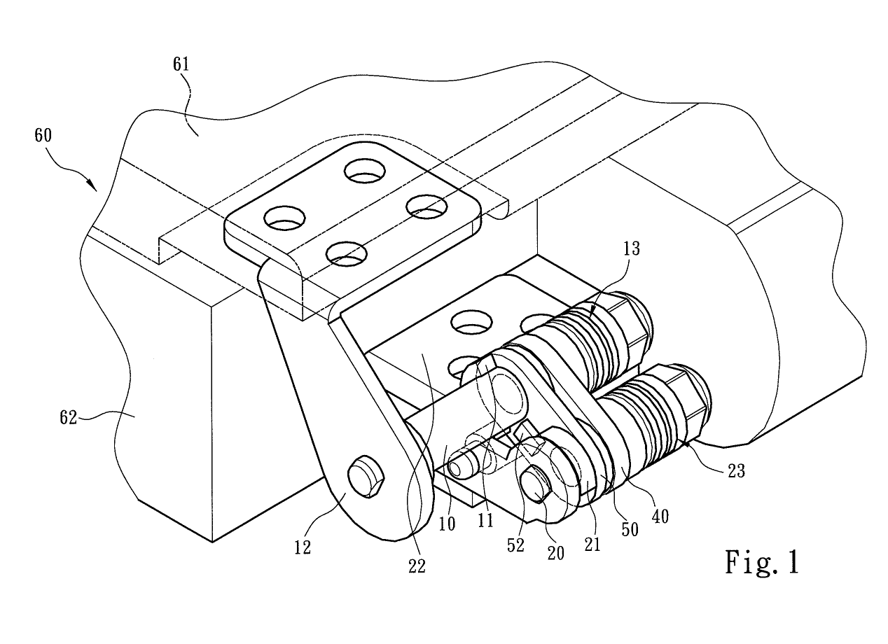

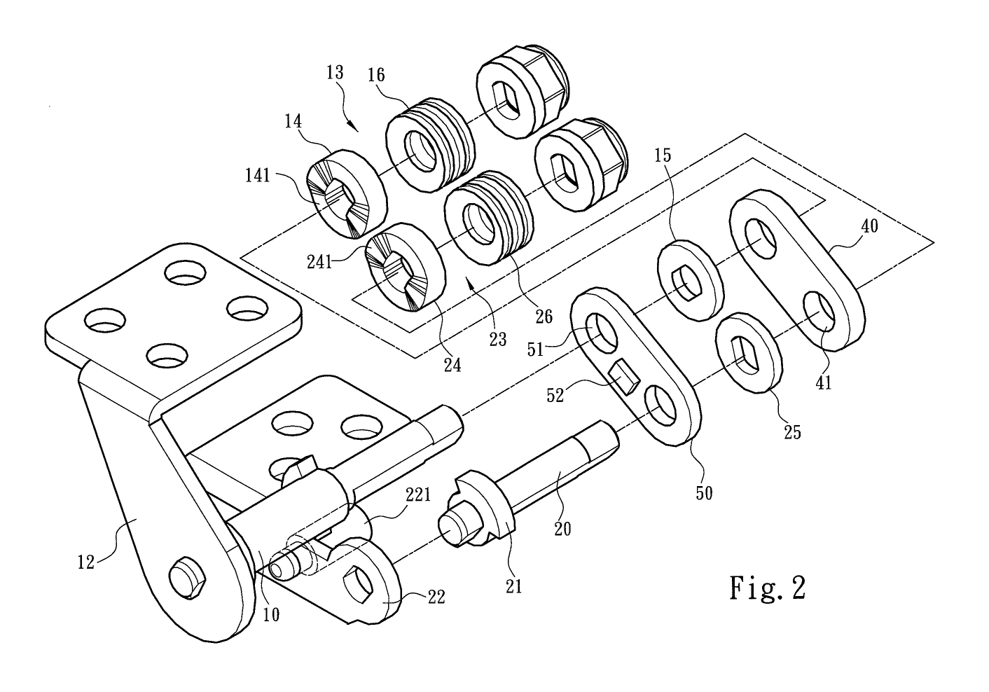

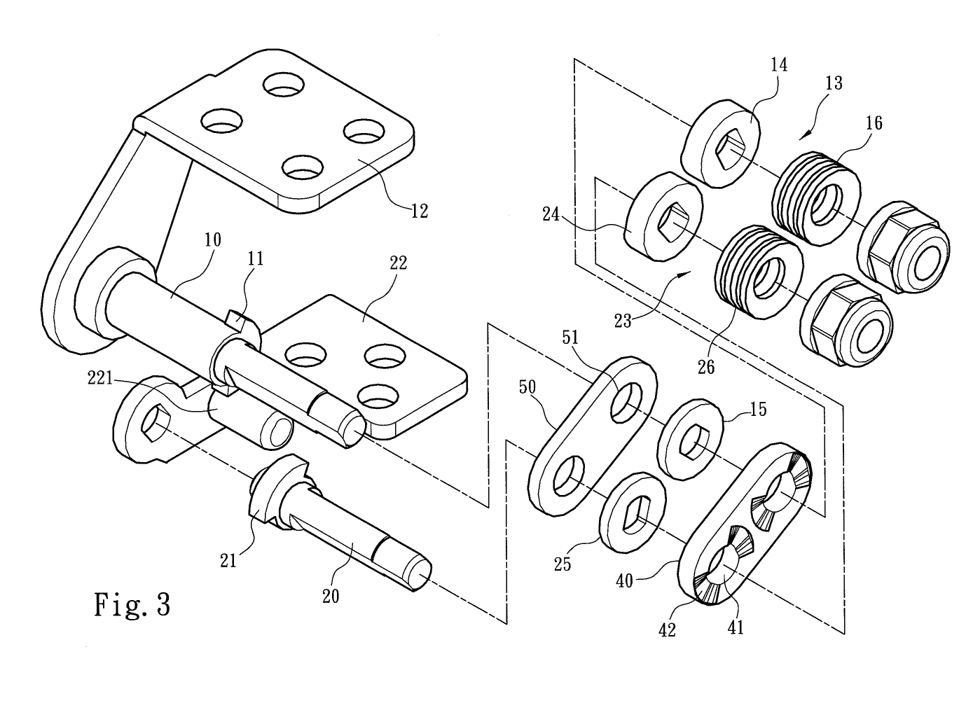

Please refer to FIGS. 1, 2 and 3, the present invention aims to provide a two-stage dual-pintle hinge which mainly includes a first axis 10, a second axis 20 and at least one connecting element to connect the first and second axes 10 and 20. The first axis 10 is connected to a first mounting plate 12 and has a first torsion unit 13 and a first anchor portion 11. The second axis 20 is connected to a second mounting plate 22 and has a second torsion unit 23 and a second anchor portion 21. The first and second torsion units 13 and 23 include respectively a cam 14 and 24, a friction pad 15 and 25, and an elastic pad 16 and 26 run through respectively by the first and second axes 10 and 20.

Refer to the drawings for an embodiment of the invention in which a first connecting element 40 and a second connecting element 50 are provided that have respectively two apertures 41 and 51 run through by the first and second axes 10 and 20 in the same direction. The first axis 10 and the first and second connecting elements 40 and 50 form a first pivot displacement. The second axis 20 and the first and second connecting elements 40 and 50 form a second pivot displacement. Moreover, the first connecting element 40 has a cam surface 42 around the circumferences of the two apertures 41 corresponding to cam surfaces 141 and 241 formed on the cams 14 and 24. The second connecting element 50 has a plane around the two apertures 51. The friction pads 15 and 25 are in contact with the first and second connecting elements 40 and 50 to provide torsional forces for the first and second pivot displacements. The second mounting plate 22 has a support member 221 supporting and butting the first and second connecting elements 40 and 50. One of the connecting elements has a third anchor portion 52 corresponding to the first and second anchor portions 11 and 21. In the drawings of the invention, the third anchor portion 52 is located on the second connecting element 50, but in practice, it also can be located on the first connecting element 40. As shown in the drawings, the first, second and third anchor portions 11, 21 and 52 are lugs to allow the first and second anchor portions 11 and 21 to form latch and anchor relationship with the third anchor portion 52 during the first and second pivot displacements.

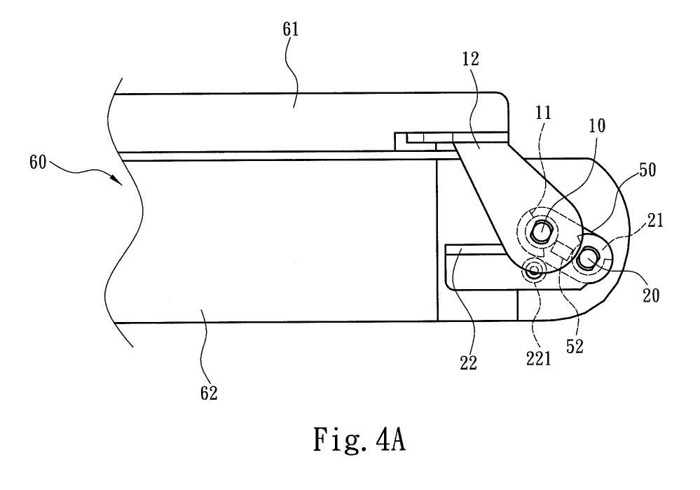

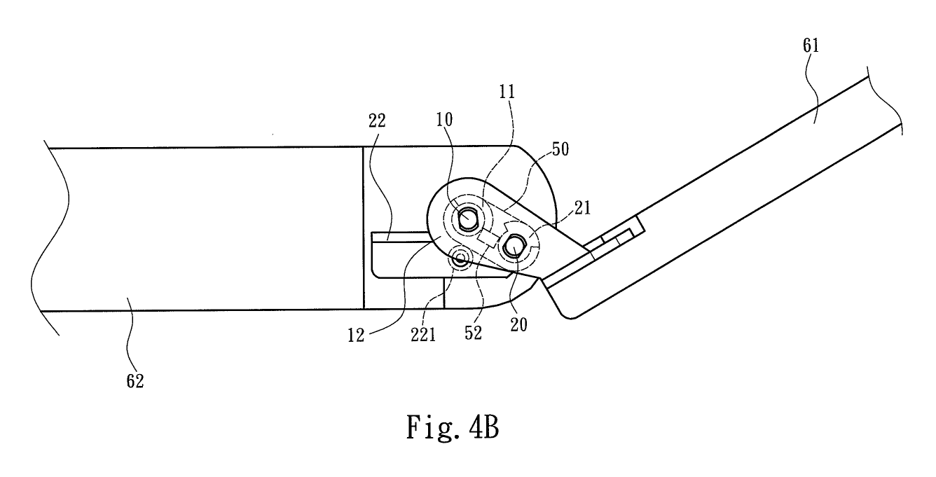

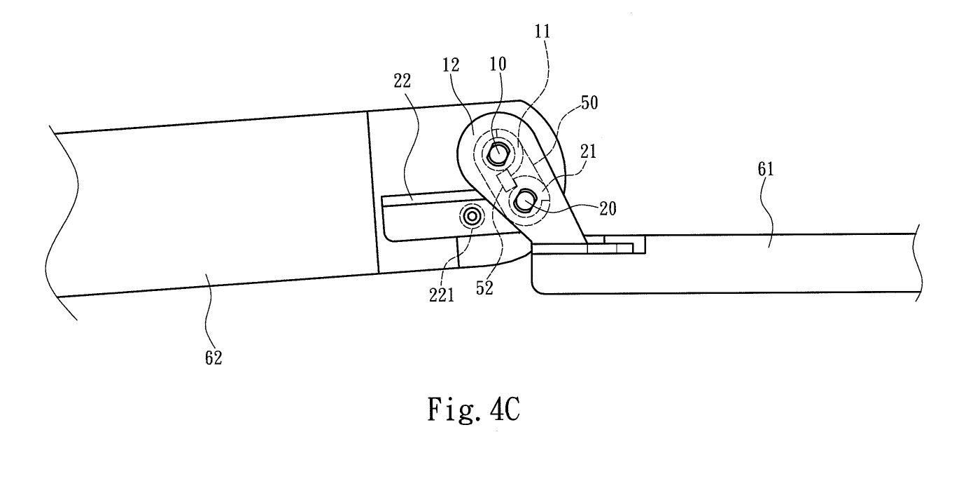

Please refer to FIGS. 4A through 4C for the invention adopted for use on a notebook computer with the first mounting plate 12 connected to a screen 61 of the notebook computer 60, and the second mounting plate 22 connected to a keyboard 62 of the notebook computer 60. When the screen 61 is folded over the keyboard 62, the first and second mounting plates 12 and 22 are in a closed condition, and the first and second connecting elements 40 and 50 lean on the support member 221 (as shown in FIG. 4A). When the screen 61 is flipped and unfolded from the keyboard 62 through an external force, the first mounting plate 12 drives the first axis 10 by the force of lifting the screen 61 to generate the first pivot displacement relative to the first and second connecting elements 40 and 50; when pivoting to about 150 degrees, the first anchor portion 11 is latched with the third anchor portion 52 to form an anchor relationship and the first pivot displacement stops (as shown in FIG. 4B); if the external force is applied to flip the screen 61 continuously, the latched first and third anchor portions 11 and 52 drive the first and second connecting elements 40 and 50 to generate the second pivot displacement relative to the second axis 20 so that pivot can be continued until reaching to about 180 degrees, then the second anchor portion 21 and the third anchor portion 52 are latched to form an anchor relationship and stop the second pivot displacement (as shown in FIG. 4C).

Although the embodiment previously discussed has two connecting elements, a single connecting element may also be used to couple the first and second axes 10 and 20 to simplify the structure regardless of the number of the connecting elements. The invention mainly provides features by having the first and second axes 10 and 20 run through by the connecting element in the same direction to form the first pivot displacement between the first axis 10 and the connecting element and the second pivot displacement between the second axis 20 and the connecting element. The first and second axes 10 and 20 and the connecting element have respectively a first, second and third anchor portions 11, 21 and 52. During the first pivot displacement of the first axis 10 and the connecting element, the first anchor portion 11 and the third anchor portion 52 form an anchor relationship to stop the first pivot displacement and drive the second pivot displacement of the connecting element and second axis 20. During the second pivot displacement, the second anchor portion 21 and the third anchor portion 52 form an anchor relationship to stop the second pivot displacement. Hence the second pivot displacement of the connecting element and the second axis 20 is driven and performed only after the first pivot displacement of the first axis 10 and the connecting element has finished, thus a constant pivot sequence is formed. Moreover, the first and second axes 10 and 20 can be coupled with the connecting element to form the anchor effect to provide auxiliary support, and also increase the lifespan.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A two-stage dual-pintle hinge, comprising:
a first axis including a first torsion unit and a first anchor portion;
a second axis including a second torsion unit and a second anchor portion; and
at least one connecting element which includes two apertures run through by the first axis and the second axis in the same direction to form a first pivot displacement between the first axis and the connecting element and form a second pivot displacement between the second axis and the connecting element, the connecting element including a third anchor portion corresponding to the first and second anchor portions;
wherein the first and third anchor portions form an anchor relationship to stop the first pivot displacement during the first pivot displacement between the first axis and the connecting element, and drive the second pivot displacement between the connecting element and the second axis; during the second pivot displacement, the second anchor portion and the third anchor portion form an anchor relationship to stop the second pivot displacement.

2. The two-stage dual-pintle hinge of claim 1, wherein the connecting element includes a cam surface surrounding the circumferences of the two apertures, the first and second torsion units including respectively a cam having the cam surface run through by the first and second axes.

3. The two-stage dual-pintle hinge of claim 2, wherein the first and second torsion units include respectively a friction pad and an elastic pad run through by the first and second axes.

4. The two-stage dual-pintle hinge of claim 1, wherein the connecting element is a plane, the first and second torsion units include respectively a friction pad in contact with the connecting element and run through by the first and second axes.

5. The two-stage dual-pintle hinge of claim 4, wherein the first and second torsion units include respectively a cam and an elastic pad run through by the first and second axes.

6. The two-stage dual-pintle hinge of claim 1, wherein the first, second and third anchor portions are lugs for latching and anchoring.

7. The two-stage dual-pintle hinge of claim 1, wherein the first and second axes connect respectively a first mounting plate and a second mounting plate, the second mounting plate includes a support member to support and butt the connecting element.

8. A two-stage dual-pintle hinge, comprising:
a first axis including a first torsion unit and a first anchor portion;
a second axis including a second torsion unit and a second anchor portion;
a first connecting element which includes two apertures run through by the first axis and the second axis in the same direction, and a cam surface surrounding the circumferences of the two apertures; and
a second connecting element which includes other two apertures run through by the first axis and the second axis in the same direction, and a plane being formed on the two apertures;
wherein the first axis and the first and second connecting elements form a first pivot displacement, and the second axis and the first and second connecting elements form a second pivot displacement, one of the connecting elements including a third anchor portion corresponding to the first and second anchor portions;
wherein the first and third anchor portions form an anchor relationship to stop the first pivot displacement during the first pivot displacement of the first axis and drive the second pivot displacement; during the second pivot displacement, the second anchor portion and the third anchor portion forming an anchor relationship to stop the second pivot displacement.

9. The two-stage dual-pintle hinge of claim 8, wherein the first and second torsion units include respectively a cam having cam surface and run through by the first and second axes.

10. The two-stage dual-pintle hinge of claim 9, wherein the first and second torsion units include respectively a friction pad in contact with the first and second connecting elements and run through by the first and second axes.

11. The two-stage dual-pintle hinge of claim 10, wherein the first and second torsion units include respectively an elastic pad run through by the first and second axes.

12. The two-stage dual-pintle hinge of claim 8, wherein the first, second and third anchor portions are lugs for latching and anchoring.

13. The two-stage dual-pintle hinge of claim 8, wherein the first and second axes connect respectively a first mounting plate and a second mounting plate, the second mounting plate includes a support member to support and butt the first and second connecting elements.
